(19) United States
(12) Patent Application Publication
(10) Pub. No.: US 2013/0313402 A1
(43) Pub. Date: Nov. 28, 2013

(54) TOOL HANGER

(71) Applicant: MING-HUNG LIN, Taichung City (TW)

(72) Inventor: MING-HUNG LIN, Taichung City (TW)

(21) Appl. No.: 13/792,038

(22) Filed: Mar. 9, 2013

(30) Foreign Application Priority Data
May 28, 2012 (TW) 101210194

(51) Int. Cl. F16M 13/02

(52) U.S. Cl. CPC F16M 13/02
USPC 248/686

(57) ABSTRACT

A tool hanger includes a hanging member and a tool holding member. The tool holding member can be folded up and fitted in a connection hold of a tool, such as a socket. The tool is then engaged by the tool holding member. The distal end of the tool holding member undetachably clips on the other end of the tool holding member. Thus, the unauthorized removal of the tool is prohibited, and burglarproof function is achieved.

### BACKGROUND OF THE INVENTION

1. Field of the Invention

The present invention relates to a displaying device or a hanger for displaying socket, connector, or linkage on a shelf.

2. Description of the Prior Art

Conventional hangers for displaying socket or connector are usually provided with locking functions. Therefore, unauthorized removal of the merchandise is prohibited to fight against the malice. For example, socket hanger which includes a hanging plate, a hanging piece, and an elastic slice. The hanging piece has an engagement portion at a lower portion thereof. The engagement portion is inserted in a connection hole of a socket, so that the socket is removably attached to the engagement portion. An engagement slice is then inserted into a through hole of the socket, engaging the engagement portion with a hook portion disposed at a top end of the engagement slice. A bottom edge of the engagement slice abuts against a step portion of the socket between the connection hole and the through hole. As such, the malice can not remove the socket from the engagement portion. The function of burglarproof is then achieved.

However, the hangers mentioned above are not suitable for sockets or tools which have no through hole.

The present invention is, therefore, arisen to obviate or at least mitigate the above mentioned disadvantages.

### SUMMARY OF THE INVENTION

The main object of the present invention is to provide a burglarproof tool hanger which performs dependable fixing, engaging, and anti-detaching functions.

To achieve the above and other objects, a tool hanger of the present invention is provided for a tool to be hung thereon. The tool has a connection hole. A side wall of the tool in the connection hole is radially recessed as a groove. The tool hanger includes a hanging member and a tool holding member.

The hanging member is formed with a hanging hole.

The tool holding member comprises a fixation mechanism and a burglarproof mechanism. The fixation mechanism is disposed to the hanging member. One end of the burglarproof mechanism is pivotably disposed to the fixation mechanism. The burglarproof mechanism comprises a protrusion and an engagement portion.

The burglarproof mechanism pivots toward the hanging member and inserts into the connection hole of the tool, so that the protrusion mates and engages the groove. The burglarproof mechanism is pushed by the tool when the tool moves toward the hanging member, so that a distal end of the burglarproof mechanism slides toward the hanging member along the fixation mechanism until the engagement portion is fixed to the fixation mechanism.

Therefore, the tool hanger is fitted for various tools and is provided with excellent burglarproof function.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a schematic drawing showing a using condition of a first embodiment of the present invention before the socket is firmly engaged;

FIG. 3 is a profile showing a first embodiment of the present invention;

FIG. 4 is a profile showing a using condition of a first embodiment of the present invention;

FIG. 5 is an A-A profile of FIG. 4;

FIG. 6 is a schematic drawing showing a using condition of a first embodiment of the present invention after the socket is firmly engaged;

FIG. 7 is a schematic drawing showing a using condition of a first embodiment of the present invention for removing the tool hanger.

### DETAILED DESCRIPTION OF THE PREFERRED EMBODIMENTS

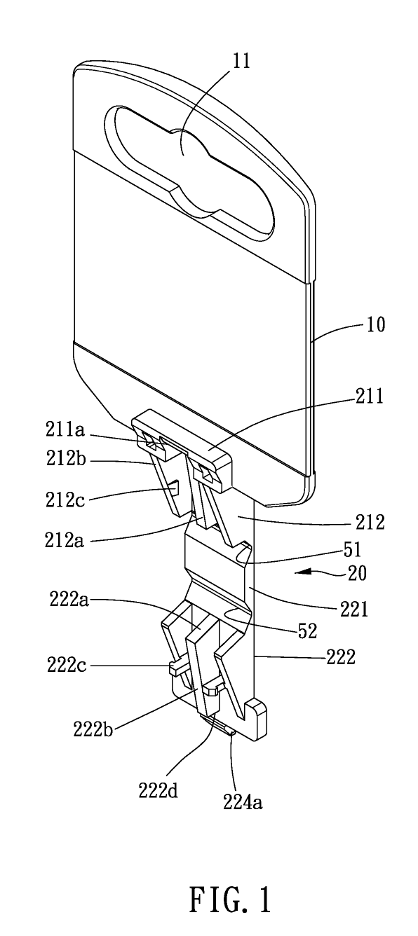

Please refer to FIG. 1 to FIG. 3 for a first embodiment of the present invention. The tool hanger of the present embodiment includes a hanging member 10 and a tool holding member 20.

The hanging member 10 is formed with a hanging hole 11 which is adapted for a hook or a pole to pierce therethrough. Thus, the hanging member 10 can be hung on wall or a shelf.

The tool holding member 20 includes a fixation mechanism and a burglarproof mechanism. The fixation mechanism is disposed to the hanging member. One end of the burglarproof mechanism is pivotably disposed to the fixation mechanism.

The fixation mechanism includes a fixation portion 211 and a guiding portion 212. The fixation portion 211 protrudes from a foreside of the hanging member 10, preferably from a bottom edge of the hanging member 10. The guiding portion 212 stretches downwardly from one end of the fixation portion 211. The fixation portion 211 includes a slant surface 211a. The guiding portion 212 includes several ribs 212a. Each rib 212a is formed with a slant surface 212b. In the present embodiment, the guiding portion includes three ribs 212a. The slant surface of the middle rib corresponds to the slant surface of the fixation portion, and the slant surfaces are formed with an interval therebetween. Thus, a step surface is formed between the slant surface of the middle rib and the slant surface of the fixation portion. The other ribs are formed with two hook portions 212c, and the ribs are arranged apart from the middle rib, located at two opposite sides of the middle rib.

The burglarproof mechanism includes a first plate 221, a second plate 222, a protrusion 223, and an engagement portion 224. One end of the first plate 221 is pivotably disposed to a distal end of the guiding portion 212 away from the fixation portion 211. One end of the second plate 222 is pivotably disposed to a distal end of the first plate 221. An inner side of the second plate 222 is formed with several protruding portions 222a. Each protruding portion 22a is formed with a slant surface 222b. In the present embodiment, the second plate 222 has three protruding portions 222a. The middle protruding portion corresponds to the middle rib. The other two protruding portions corresponds to the other two rids, and are arranged apart from the middle protruding portion, located at two opposite sides of the middle protruding portion. On inner sides of the two protruding portions are disposed with two protruding wedging pieces 222c. The protrusion 223 is disposed to the second plate 22, located at a side of the second plate opposite to the slant surface 222b. A first V-shaped groove 51 is formed between the first plate 221 and the guiding portion 212. A second V-shaped groove 52 is formed between the first plate 221 and the second plate 222. Preferably, the rib 212a of the guiding portion and the first V-shaped groove 51 are arranged with a gap therebetween. Similarly, the protruding portion 222a of the second plate and the second V-shaped groove 52 are arranged with a gap therebetween. The engagement portion 224 has a head portion 224a and a neck portion 224b. The head portion 224a is shrunk away from the neck portion 224b, so that the head portion 224a is formed with a slant surface 224c. The slant surface 224c of the head portion and the slant surface 222b of the second plate are located at same side of the tool hanger. The head portion 224a protrudes inwardly form the neck portion 224b at a border portion between the head portion 224a and the neck portion 224b, so that the head portion 224a is formed as a hook or a hanger. A step surface 222d is formed between the neck portion 224b and the slant surface 222b of the middle protruding portion of the second plate. A restriction groove 30 is defined by the head portion 224a, the neck portion 224b, and the step surface 222d.

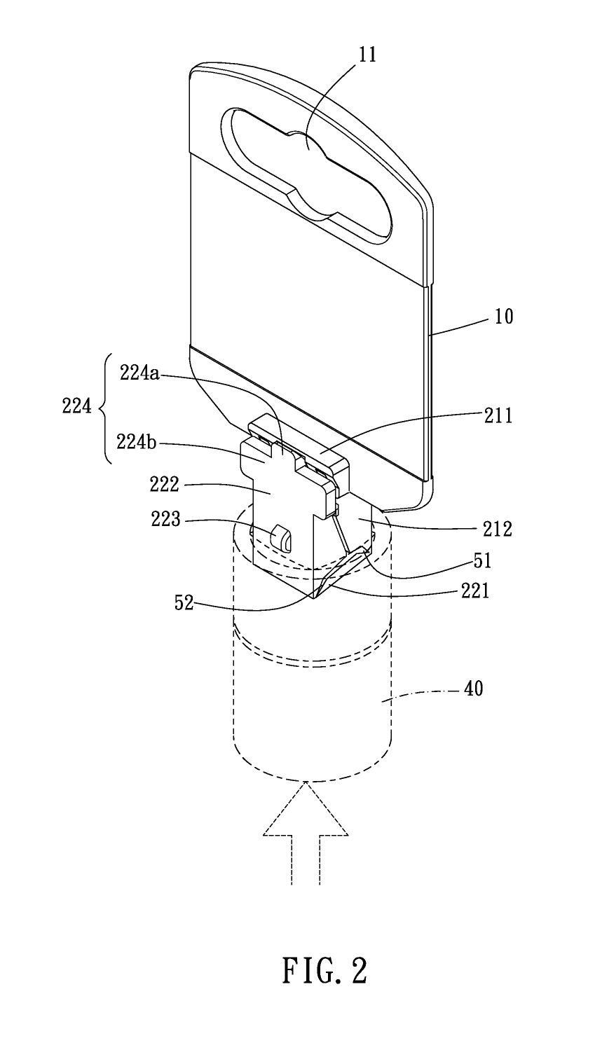

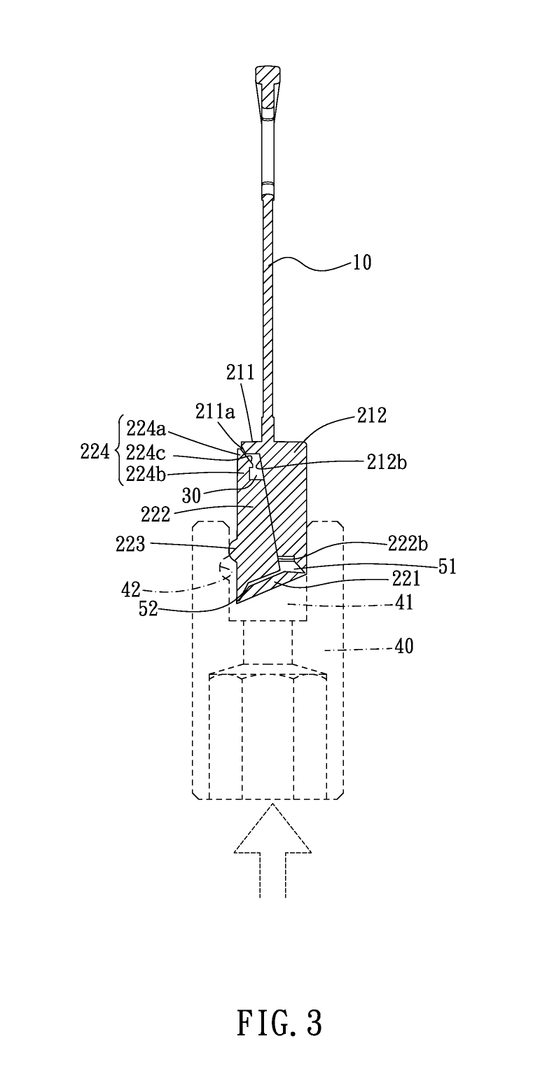

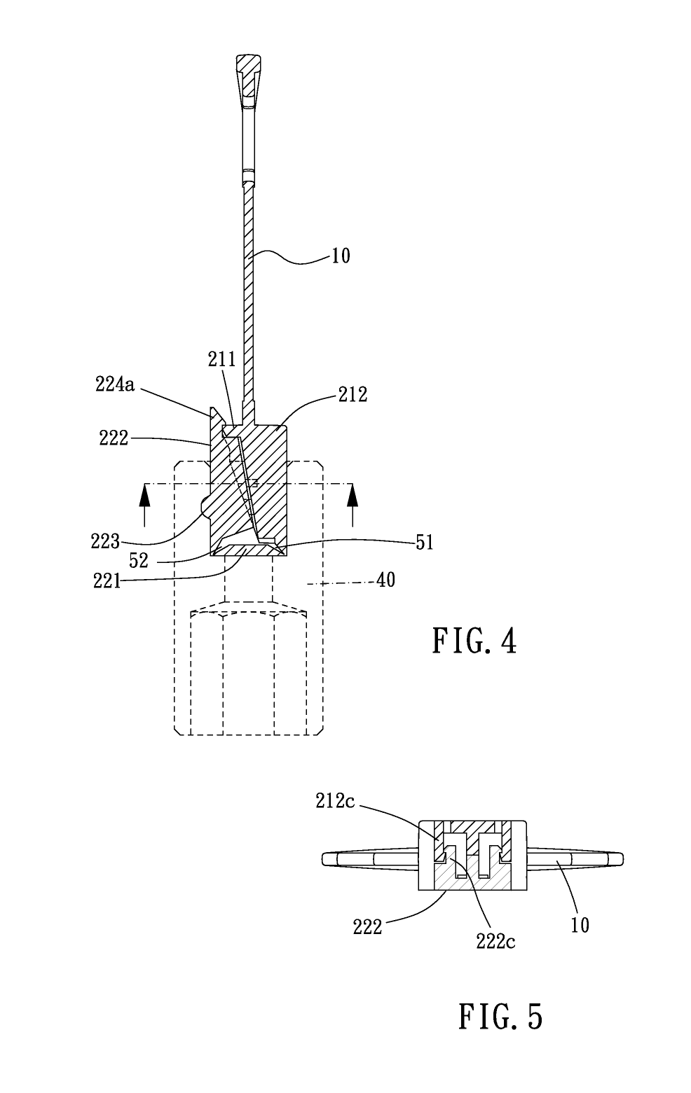

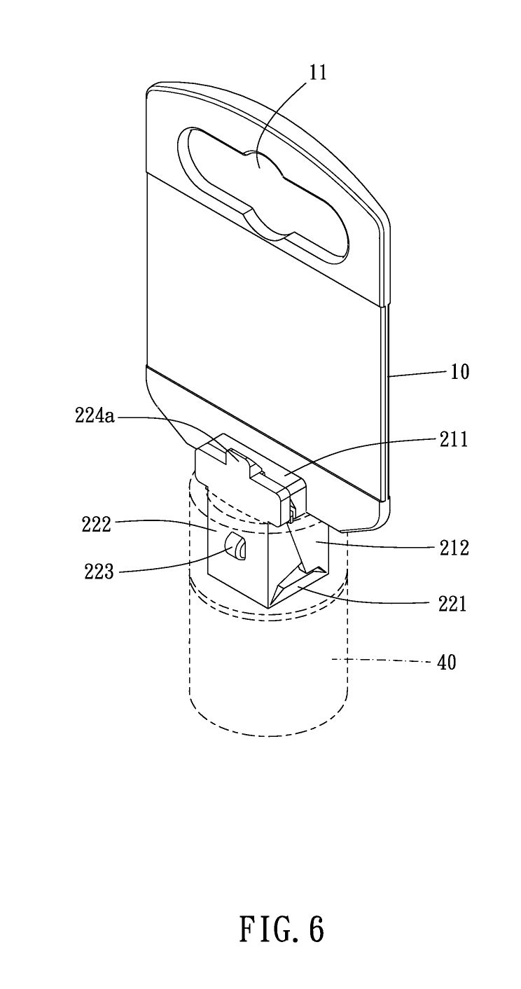

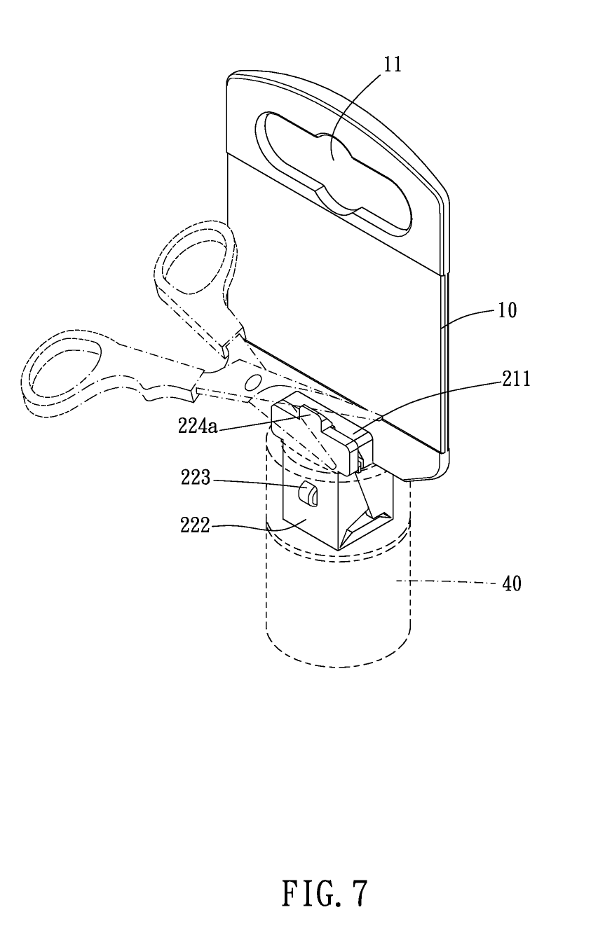

Please refer to FIG. 2. The tool hanger of the present embodiment is provided for a tool to be positioned and hung thereon. In the present embodiment, the tool, such as sockets, especially the sockets provided for pneumatic tools or power tools, has a connection hole 41 axially arranged at one end. A side wall of the tool in the connection hole 41 is radially recessed as a groove 42. However, the socket mentioned is taken for presentation and explanation only. Other types of socket or similar tool, such as connector or linkage, can be held and hung by the tool hanger. Please refer to FIG. 2 and FIG. 3. For firmly positioning the socket 40 on the tool hanger, the first plate 221 of the burglarproof mechanism is firstly swung toward the hanging member 10. Two side walls of the first V-shaped groove 51 are moved close to each other, and the first V-shaped groove 51 is diminished in width. The second plate 222 is then swung toward the hanging member 10. Two side walls of the second V-shaped groove 52 are moved close to each other, and the second V-shaped groove 52 is diminished, also. The first plate 221 abuts against the bottom portion of the second plate 222. When the socket 40 is moved toward the hanging member 10, the protrusion 223 is firstly positioned in the groove 42. The first plate 221 and the second plate 222 are moved toward the hanging member 10. The slant surfaces 222b of the protruding portions abut against and slide along the corresponding slant surfaces 212b of the ribs of the guiding portion. When the second plate 222 continuously slides toward the hanging member 10 and the head portion 224a touches the fixation portion 211, the slant surface 224c of the head portion abuts against and slides along the slant surface 211a of the fixation portion. During the slide, the region or thickness where the second plate 222 overlapping the guiding portion 212 is getting larger until a top surface of the fixation portion 211 abuts against a bottom surface of the head portion 224a. Then the fixation portion 211 engages the restriction groove, and the wedging pieces 222c engage the corresponding hook portions 212c, as shown in FIG. 4 and FIG. 5. Since then, the total thickness of the second plate 222 and the guiding portion 212 reaches a predetermined maximum value which fits for the inner diameter of the connection hole of the socket. Thus, the burglarproof mechanism is engaged and stuck on the fixation mechanism so as to hold the socket tightly on the tool hanger. Unpredictable removal is then prohibited, as shown in FIG. 6. Please refer to FIG. 7. After customers possess the socket lawfully, the head portion 224a can be removed by a knife or shears. The fixation portion 211 is then released from the restriction groove, and the socket 40 can be removed from the tool hanger easily.

In another embodiment of the present invention, the guiding portion may be formed with a rectangular appearance, with no slant surface thereon. The contact surface of the second plate to the guiding portion may be a perpendicular surface. The contact surfaces of the fixation portion and the head portion may be perpendicular surfaces, also. However, the functions of engaging and holding the tool can still provided by the tool hanger.

Accordingly, the tool hanger provides the function of burglarproof. In addition, the tool hanger is provided fitting for various tools.

What is claimed is:

1. A tool hanger, provided for a tool to be hung thereon, the tool having a connection hole, a side wall of the tool in the connection hole being radially recessed as a groove, the tool hanger comprising:
a hanging member, formed with a hanging hole;
a tool holding member, comprising a fixation mechanism and a burglarproof mechanism, the fixation mechanism being disposed to the hanging member, one end of the burglarproof mechanism being pivotably disposed to the fixation mechanism, the burglarproof mechanism comprising a protrusion and an engagement portion;
wherein the burglarproof mechanism pivots toward the hanging member and inserts into the connection hole of the tool, so that the protrusion mates and engages the groove, the burglarproof mechanism is pushed by the tool when the tool moves toward the hanging member, so that a distal end of the burglarproof mechanism slides toward the hanging member along the fixation mechanism until the engagement portion is fixed to the fixation mechanism.

2. The tool hanger of the claim 1, wherein the burglarproof comprises a first plate and a second plate, one end of the first plate is pivotably disposed to a distal end of the fixation mechanism away from the hanging member, one end of the second plate is pivotably disposed to a distal end of the first plate.

3. The tool hanger of claim 2, wherein the fixation mechanism comprises a fixation portion which protrudes from the hanging member, the second plate is formed with a slant surface at an inner side thereof, the engagement portion has a head portion and a neck portion, the head portion protrudes inwardly form the neck portion at a border portion between the head portion and the neck portion, a step surface is formed between the neck portion and the slant surface of the second plate, the head portion, the neck portion, and the step surface define a restriction groove, when the second plate slides toward the hanging member, the head portion touches the fixation portion firstly, a top surface of the fixation portion then abuts against a bottom surface of the head portion, and the fixation portion is finally engaged in the restriction groove.

4. The tool hanger of claim 3, wherein the fixation mechanism comprises a guiding portion which comprises a slant surface, the slant surface of the second plate abuts against and slides along the slant surface of the guiding portion when the second plate slides toward the hanging member.

5. The tool hanger of claim 4, wherein a V-shaped groove is formed between the first plate and the guiding portion, another V-shaped groove is formed between the first plate and the second plate.

6. The tool hanger of claim 3, wherein the fixation portion comprises a slant surface, the head portion comprises a slant surface, when the second plate slides toward the hanging member and the head portion touches the fixation portion, the slant surface of the head portion abuts against and slides along the slant surface of the fixation portion until the fixation portion is engaged in the restriction groove.

7. The tool hanger of claim 3, wherein the protrusion is disposed to the second plate, located at a side of the second plate opposite to the slant surface.

8. The tool hanger of claim 2, wherein the fixation mechanism comprises at least a hook portion, the second plate comprises at least a wedging piece, the wedging piece selectively engages the hook portion.

9. The tool hanger of claim 8, wherein the fixation mechanism comprises a guiding portion, the hook portion is disposed to the guiding portion.
